(19) United States
(12) Patent Application Publication
(10) Pub. No.: US 2026/0171445 A1
(43) Pub. Date: Jun. 18, 2026

(54) HYBRID HYDROGEN CHARGING SYSTEM AND METHOD

(71) Applicants: Hyundai Motor Company, Seoul (KR); Kia Corporation, Seoul (KR)

(72) Inventors: Jaeyong Lee, Hwaseong-Si (KR); Pyung Soon Kim, Hwaseong-Si (KR); Ji-Hoon Jang, Hwaseong-Si (KR); Jihui Seo, Hwaseong-Si (KR); Hanjin Kim, Hwaseong-Si (KR); Narae Yoon, Hwaseong-Si (KR); Jihye Park, Hwaseong-Si (KR)

(21) Appl. No.: 19/254,495

(22) Filed: Jun. 30, 2025

(30) Foreign Application Priority Data
Dec. 16, 2024 (KR) 10-2024-0186759

(51) Int. Cl. H01M 8/04082; H01M 8/0438; H01M 8/04746; H01M 8/065; H01M 8/0668

(52) U.S. Cl. CPC H01M 8/04216; H01M 8/04425; H01M 8/04753; H01M 8/04776; H01M 8/065; H01M 8/0668; H01M 2250/20

(57) ABSTRACT

An apparatus may comprise a solid-phase hydrogen supply system configured to generate, based on a chemical reaction of a chemical hydride, hydrogen gas in a first pressure range, a compression system configured to selectively change a pressure of the hydrogen gas generated by the solid-phase hydrogen supply system to a second pressure range that extends beyond the first pressure range, and a dispenser configured to provide hydrogen gas to a charging target from at least one of the solid-phase hydrogen supply system or the compression system.

### CROSS-REFERENCE TO RELATED APPLICATION

This application claims benefit of priority to Korean Patent Application No. 10-2024-0186759 filed at the Korean Intellectual Property Office on Dec. 16, 2024, the entire contents of which are incorporated herein by reference.

### FIELD

The present disclosure relates to a hybrid hydrogen charging system and method, and more particularly, to a hybrid hydrogen charging system and method capable of combining a compressed hydrogen supply system and a solid-phase hydrogen supply system.

### BACKGROUND

The matters described in this Background section are only for enhancement of understanding of the background of the disclosure, and should not be taken as acknowledgment that they correspond to prior art already known to those skilled in the art.

Due to the depletion of fossil fuels and environmental pollution, there is a great demand for renewable and alternative energy sources, and hydrogen is attracting attention as one such alternative.

Fuel cells and hydrogen combustion devices use hydrogen as a reaction gas, but in order to apply fuel cells and hydrogen combustion devices to automobiles (e.g., fuel cell vehicles) and various electronic products, technology for stable and continuous hydrogen supply may be applied.

In order to supply hydrogen gas to a charging target 40 such as a fuel cell electric vehicle, a separate hydrogen charging station may be installed in each region, and the fuel cell electric vehicle may move to the hydrogen charging station to be charged with hydrogen gas.

Hydrogen tanks filled with low-pressure hydrogen gas (e.g., 5 to 200 bar) may be supplied to the hydrogen charging station via trailers, etc., and the low-pressure hydrogen gas stored in the hydrogen tank may be compressed to high pressure (e.g., 875 bar) using a mechanical compressor and supplied to the charging target.

Mechanical compressors may use a method of directly compressing low-pressure hydrogen gas into high-pressure hydrogen gas (hereinafter referred to as a “compressed hydrogen supply method”). However, depending on the need (for example, to reduce hydrogen compression time, increase compression efficiency, or secure the durability of the charging facility), a low-pressure hydrogen gas may be first compressed into medium-pressure hydrogen gas (for example, 200 to 400 bar), and then secondarily compressed into high-pressure hydrogen gas and supplied to the charging target.

On the other hand, a method of generating hydrogen by injecting an acid aqueous solution, an acid catalyst, or water and an acid catalyst into a solid-phase hydride stored in a dehydrogenation reactor to supply hydrogen gas to the charging target 40 (hereinafter referred to as a “solid-phase hydrogen supply method”) may also be considered.

In order to charge a charging target with the compressed hydrogen supply method, a separate large transportation means such as a trailer may be used to supply hydrogen gas to the hydrogen station, and a separate space to place the hydrogen tank from the trailer may be used, resulting in increased carbon emissions and increased transportation costs.

In addition, although the solid-phase hydrogen supply method may generate high-pressure hydrogen gas, there may be a problem in that the material and configuration of the reactor must be designed to withstand high pressure, and separate equipment is used for heat management of the reactor.

### SUMMARY

The present disclosure attempts to provide a hybrid hydrogen charging system and a method capable of utilizing both a compressed hydrogen supply method and a solid-phase hydrogen supply method to reduce space and transportation costs for hydrogen charging station sites and to ensure durability.

According to the present disclosure, an apparatus may comprise a solid-phase hydrogen supply system configured to generate, based on a chemical reaction of a chemical hydride, hydrogen gas in a first pressure range, a compression system configured to selectively change a pressure of the hydrogen gas generated by the solid-phase hydrogen supply system to a second pressure range that extends beyond the first pressure range, and a dispenser configured to provide hydrogen gas to a charging target from at least one of the solid-phase hydrogen supply system or the compression system.

The apparatus, wherein the compression system may comprise a hydrogen compressor configured to pressurize the hydrogen gas generated by the solid-phase hydrogen supply system, and a hydrogen tank configured to store the hydrogen gas pressurized by the hydrogen compressor.

The apparatus, wherein the solid-phase hydrogen supply system may comprise an acid aqueous solution tank configured to store acid aqueous solution, at least one dehydrogenation reactor configured to store the chemical hydride and selectively provide the acid aqueous solution stored in the acid aqueous solution tank to generate hydrogen gas, and a cooler configured to control a temperature of the at least one dehydrogenation reactor.

The apparatus, wherein the solid-phase hydrogen supply system further may comprise a purging assembly configured to discharge impurity gas from the dehydrogenation reactor. The apparatus, wherein the purging assembly may comprise a purging pipe configured to fluidly connect the dehydrogenation reactor to a discharge outlet located outside the solid-phase hydrogen supply system, and a purging valve provided in the purging pipe, downstream of the dehydrogenation reactor.

The apparatus, wherein the purging assembly further may comprise a vacuum pump provided in the purging pipe, downstream of the purging valve. The apparatus may further comprise a buffer tank configured to temporarily store hydrogen gas generated from the at least one dehydrogenation reactor.

The apparatus, wherein the compression system further may comprise a booster pump provided between the buffer tank and the hydrogen tank. The apparatus, wherein the solid-phase hydrogen supply system may comprise a back-pressure regulator provided upstream of the buffer tank, and a gas purifier provided upstream of the back-pressure regulator.

According to the present disclosure, a method performed by an apparatus may comprise a compression system and a solid-phase hydrogen supply system, the method may comprise determining, based on an internal pressure of a dehydrogenation reactor or an internal pressure of a buffer tank, whether the dehydrogenation reactor is performing a dehydrogenation reaction to generate hydrogen gas, determining, based on an internal pressure of a hydrogen tank, whether a booster pump and a hydrogen compressor are compressing hydrogen gas from the buffer tank into the hydrogen tank, and supplying, based on a required charging pressure associated with a charging target, hydrogen gas to the charging target by, supplying hydrogen gas stored in the hydrogen tank to the charging target, or supplying hydrogen gas stored in the buffer tank to the charging target.

The method, wherein the determining of whether the dehydrogenation reactor is performing the dehydrogenation reaction to generate hydrogen gas may comprise determining whether the internal pressure of the dehydrogenation reactor or the internal pressure of the buffer tank is greater than or equal to a first set pressure. The method may further comprise, based on the internal pressure of the dehydrogenation reactor or the internal pressure of the buffer tank being less than the first set pressure, controlling the dehydrogenation reactor to perform the dehydrogenation reaction to generate hydrogen gas.

The method may further comprise, based on the internal pressure of the dehydrogenation reactor or the internal pressure of the buffer tank being greater than or equal to the first set pressure, stopping the performance of the dehydrogenation reaction by the dehydrogenation reactor. The method, wherein the determining of whether the booster pump and the hydrogen compressor are compressing hydrogen gas from the buffer tank into the hydrogen tank may comprise determining whether the internal pressure of the hydrogen tank is less than a second set pressure.

The method may further comprise, based on the internal pressure of the hydrogen tank being less than the second set pressure, operating the booster pump and the hydrogen compressor to compress hydrogen gas stored in the buffer tank and store the compressed hydrogen gas in the hydrogen tank. The method may further comprise, based on the internal pressure of the hydrogen tank being greater than or equal to the second set pressure, stopping operations of the booster pump and the hydrogen compressor.

According to the present disclosure, an apparatus may comprise a solid-phase hydrogen generation system configured to produce hydrogen gas via a reaction between a solid-phase hydrogen storage material and a reactive liquid, a storage vessel configured to receive and store the hydrogen gas generated by the solid-phase hydrogen generation system, a compressor configured to increase a pressure of the hydrogen gas from the storage vessel, a tank configured to store the hydrogen gas compressed by the compressor, and a dispenser configured to supply hydrogen gas to a hydrogen-receiving device from at least one of the storage vessel or the tank. The apparatus, wherein the solid-phase hydrogen generation system may comprise an acid aqueous solution tank configured to store an acid aqueous solution, and a dehydrogenation reactor configured to receive a chemical hydride and mix the acid aqueous solution with the chemical hydride to produce hydrogen gas.

The apparatus may further comprise a cooler configured to control a temperature of a dehydrogenation reactor, wherein the cooler may comprise a chiller and a cooling pump. The apparatus, wherein the dispenser is configured to, based on a charging pressure of the hydrogen-receiving device being within a first pressure range, supply hydrogen gas from the storage vessel, and based on the charging pressure being within a second pressure range, supply hydrogen gas from the tank.

In addition, the effects that can be obtained or expected from examples of the present disclosure are directly or implicitly disclosed in the detailed description of the present disclosure. That is, various effects predicted according to the present disclosure will be disclosed in the detailed description that follows.

### BRIEF DESCRIPTION OF THE DRAWINGS

Since these drawings are for reference in describing examples of the present disclosure, the technical ideas of the present disclosure should not be construed as limited to the attached drawings.

FIG. 1 shows an exemplary configuration of a hybrid hydrogen charging system according to an example.

FIG. 2 shows an exemplary configuration of a hybrid hydrogen charging system according to an example.

FIG. 3A and FIG. 3B show an example of a control method of a hybrid hydrogen charging system according to an example.

FIG. 4 shows an example computing system (e.g., a computing device of a hybrid hydrogen charging system, a vehicle, or any other apparatus).

It should be understood that the drawings referenced above are not necessarily drawn to scale, but rather present somewhat simplified representations of various preferred features that illustrate the basic principles of the present disclosure. For example, specific design features of the present disclosure, including particular dimensions, directions, positions, and shapes, will be determined in part by the particular intended application and usage environment.

### DETAILED DESCRIPTION

The terminology used herein is for the purpose of describing particular examples only and is not intended to be limiting of the present disclosure. As used herein, singular forms are intended to include plural forms as well, unless the context clearly indicates otherwise. It should be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any one or all combinations of one or more related items.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Additionally, it should be understood that one or more of the methods or examples thereof below may be executed by at least one controller. The term “controller” may refer to a hardware device that includes memory and a processor. The memory is configured to store program instructions, and the processor is specifically programmed to execute the program instructions to perform one or more processes described in more detail below. The controller may control the operation of units, modules, components, devices, or the like, as described herein. Additionally, it should be understood that the methods below may be implemented by a device including a controller together with one or more other components, as would be recognized by those skilled in the art.

Additionally, the controller of the present disclosure may be implemented as a non-transitory computer-readable recording medium including executable program instructions executed by a processor. Examples of computer-readable recording medium include, but are not limited to, ROMs, RAMs, compact disc (CD) ROMs, magnetic tapes, floppy disks, flash drives, smart cards, and optical data storage devices. The computer-readable recording medium may also be distributed across a computer network so that program instructions may be stored and executed in a distributed manner, such as on a telematics server or a controller area network (CAN).

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

The present disclosure will be described in detail hereinafter with reference to the accompanying drawings, in which examples of the present disclosure are shown. As those skilled in the art would realize, the described examples may be modified in various different ways, all without departing from the spirit or scope of the present disclosure.

The drawings and description are to be regarded as illustrative in nature and not restrictive, and like reference numerals designate like elements throughout the specification.

Further, since sizes and thicknesses of components shown in the accompanying drawings may be arbitrarily given to facilitate understanding and ease of description, the disclosure is not limited to the illustrated sizes and thicknesses, and the thicknesses are exaggerated to clearly represent various parts and areas.

The suffixes “module” and/or “part” used for components in the following description are given or used interchangeably only for the convenience of writing the specification, and do not in themselves have distinct meanings or roles.

In addition, when describing the disclosed examples, if it is determined that a detailed description of a related known technology may obscure the gist of the examples disclosed in this specification, such a detailed description is omitted.

The accompanying drawings are intended only to facilitate understanding of the examples disclosed in this specification, and it is to be understood that the technical ideas disclosed herein are not limited by the accompanying drawings and include all modifications, equivalents, or substitutions that are within the range of the ideas and technology of the present disclosure.

Although terms “first,” “second,” and the like are used to explain various components, the components are not limited to such terms.

In the description, expressions described as singular in this specification may be interpreted as singular or plural unless an explicit expression such as “one” or “single” is used.

These terms are only used to distinguish one component from another component.

Hereinafter, a hybrid hydrogen charging system according to an example is described in detail with reference to the attached drawings.

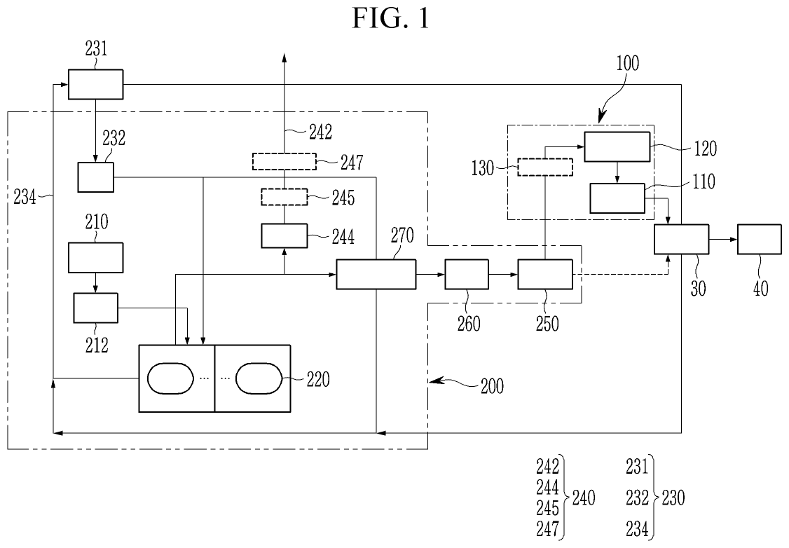

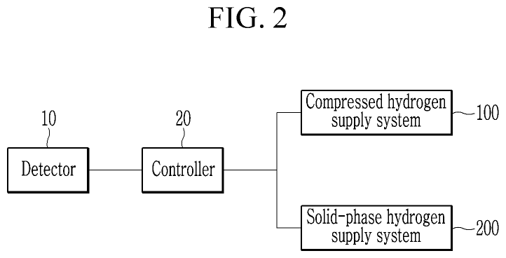

FIG. 1 shows an exemplary configuration of a hybrid hydrogen charging system according to an example. FIG. 2 shows an exemplary configuration of a hybrid hydrogen charging system according to an example.

As shown in FIGS. 1 and 2, a hybrid charging system according to an example may include a solid-phase hydrogen supply system 200 and a compressed hydrogen supply system 100.

The compressed hydrogen supply system 100 may include at least one high-pressure hydrogen compressor 120 and a high-pressure hydrogen tank 110.

The high-pressure hydrogen compressor 120 may pressurize hydrogen gas generated in the solid-phase hydrogen supply system 200 and supply the hydrogen gas to the high-pressure hydrogen tank 110 (e.g., at pressures of 700 bar, 875 bar, or 1000 bar, etc.).

The high-pressure hydrogen tank 110 may store high-pressure hydrogen gas compressed by the high-pressure hydrogen compressor 120.

The solid-phase hydrogen supply system 200 generates hydrogen gas by a chemical reaction of a chemical hydride (e.g., NaBH₄, LiBH₄, NH₃BH₃, or Ca(BH₄)₂, etc.) (hereinafter also referred to as a “reactant” as needed), and the generated hydrogen gas may be selectively supplied to a charging target 40 (e.g., a hydrogen-receiving device). In the present disclosure, the charging target 40 may be a fuel cell electric vehicle (FCEV) (e.g., a passenger car, a bus, a forklift, or a drone, etc.).

The solid-phase hydrogen supply system may include an acid aqueous solution tank 210, at least one dehydrogenation reactor 220, a thermal control device 230, and a buffer tank 250 (e.g., for pressure stabilization, temporary storage, or flow regulation, etc.).

The acid aqueous solution tank 210 stores the acid aqueous solution, and the stored acid aqueous solution may be selectively supplied to the dehydrogenation reactor 220 through an acid aqueous solution pump 212 (e.g., a diaphragm pump, peristaltic pump, or gear pump, etc.). The acid aqueous solution pump 212 may be provided between the acid aqueous solution tank 210 and the dehydrogenation reactor 220. The acid aqueous solution stored in the acid aqueous solution tank may be supplied to the dehydrogenation reactor 220 by being conveyed through the acid aqueous solution pump 212 (e.g., via controlled flow rate to regulate reaction kinetics, maintain reactor pressure, or synchronize with thermal management, etc.).

The acid aqueous solution tank 210 may be formed with a corrosion-resistant protective film, such as a Teflon coating, a fluoropolymer lining, or a ceramic-based barrier, etc., to prevent corrosion by the acid aqueous solution. The acid aqueous solution promotes dehydrogenation reactions by adjusting the pH of a chemical hydride, thereby shortening its half-life (e.g., to accelerate hydrogen release, reduce system latency, or improve reaction consistency, etc.).

The acid applied to the acid aqueous solution may be an inorganic acid such as sulfuric acid, nitric acid, phosphoric acid, boric acid, or hydrochloric acid, or an organic acid such as heteropoly acid, acetic acid, formic acid, malic acid, citric acid, tartaric acid, ascorbic acid, lactic acid, oxalic acid, succinic acid, or tauric acid, or a mixture thereof, and may be formic acid (HCOOH), which is safer than hydrochloric acid at high concentrations because of its smaller molecular weight relative to hydrogen ions, and thus can reduce a system weight.

In the case of formic acid, it is a weak acid and may be used relatively safely because it is maintained at a low pH under a predetermined condition (e.g., controlled concentration, temperature, or buffer presence, etc.). In addition, captured carbon dioxide may be obtained through hydrogenation, making it an important material in the recycling of carbon dioxide (e.g., in power-to-gas systems, carbon-neutral fuel production, or closed-loop chemical cycles, etc.). Additionally, formate is converted into bicarbonate through a dehydrogenation reaction, during which additional hydrogen may be obtained (e.g., to improve yield, increase energy efficiency, or support continuous operation, etc.).

The dehydrogenation reactor 220 may produce hydrogen gas by a chemical reaction between chemical hydride and an acid aqueous solution.

The dehydrogenation reactor 220 may be configured as a high-temperature and high-pressure vessel so that the dehydrogenation reaction may be performed under high-temperature and high-pressure conditions (e.g., 100° C. to 250° C. and 350 bar to 700 bar, etc.). For example, the dehydrogenation reactor 220 may have a cylindrical, spherical, rectangular, or polygonal columnar shape, and in particular may have a cylindrical shape (e.g., to optimize volume-to-surface area ratio, enable uniform heat distribution, or simplify manufacturing, etc.).

The chemical hydride is in a solid state, and may be in the form of, for example, powder, granular, bead, microcapsule, or pellet (e.g., for controlled reaction rate, ease of handling, or packing density, etc.).

The chemical hydride may be any compound that hydrolyzes to produce hydrogen and a hydrolyzate, and for example, may include NaBH₄, LiBH₄, KBH₄, NH₄BH₄, NH₃BH₃, (CH₃)₄NH₄BH₄, NaAlH₄, LiAlH₄, KAlH₄, Ca(BH₄)₂, Mg(BH₄)₂, NaGaH₄, LiGaH₄, KGaH₄, LiH, CaH₂, MgH₂, or mixtures thereof (e.g., selected based on hydrogen yield, thermal stability, or regeneration feasibility, etc.).

Since the hydrogen generation reaction inside the dehydrogenation reactor 220 is an exothermic reaction, the thermal control device 230 may be provided to cool the reaction heat (e.g., to prevent overheating, maintain optimal reaction temperature, or protect reactor integrity, etc.).

The thermal control device 230 may include a chiller 231 that cools a thermal medium (e.g., water-glycol mixture, silicone oil, or a refrigerant, etc.), and a cooling pump 232 that conveys the thermal medium cooled by the chiller 231 to the dehydrogenation reactor 220.

The chiller 231 and the cooling pump 232 may be fluidly connected by a cooling pipe 234 through which a thermal medium flows, and the heat medium cooled by the chiller 231 may circulate through the cooling pump 232, a dispenser 30, and the dehydrogenation reactor 220 and re-inflow into the chiller 231 (e.g., in a closed-loop or semi-open-loop configuration, etc.).

The heat medium flowing along the cooling pipe 234 may include at least one of an aqueous liquid refrigerant, an oil-based liquid refrigerant, a fluorine-based gas refrigerant, and an inorganic compound-based gas refrigerant (e.g., ammonia, CO₂, or Hydrofluoroolefins, etc.).

The cooling pump 232 may be an electric water pump (EWP) that conveys a thermal medium by electric power (e.g., using a brushless DC motor or variable-speed drive, etc.).

Hydrogen gas generated in the dehydrogenation reactor 220 may be temporarily stored in the buffer tank 250 (e.g., to regulate downstream pressure, accommodate reaction cycling, or serve as an intermediate reservoir, etc.). When the dehydrogenation reactor 220 is replaced, the remaining hydrogen gas stored in the buffer tank 250 may be discharged to the outside (e.g., via a controlled venting valve, purging system, or recovery line, etc.).

A back-pressure regulator 260 may be provided between the dehydrogenation reactor 220 and the buffer tank 250 (or upstream of the buffer tank 250) (e.g., to manage pressure transients, prevent reverse flow, or ensure stable gas output, etc.). In order to stably extract hydrogen from the dehydrogenation reactor 220, it is necessary to increase the internal pressure of the reaction vessel of the dehydrogenation reactor 220 to a specific pressure (e.g., 1 to 350 bar) and control the boiling point (100° C. to 400° C.) of the reactant to minimize the phase change of the reactant (e.g., to prevent cavitation, foaming, or premature evaporation, etc.). To this end, by installing the back-pressure regulator 260 downstream of the dehydrogenation reactor 220, the internal pressure of the reaction vessel of the dehydrogenation reactor 220 may be controlled.

A first purification device 270 for removing impurities generated inside the dehydrogenation reactor 220 may be provided between the dehydrogenation reactor 220 and the buffer tank 250 (or downstream of the dehydrogenation reactor 220, e.g., in a bypass line, inline housing, or pre-buffer filter, etc.).

When a hydride and an acid aqueous solution react in the dehydrogenation reactor 220, carbon monoxide and water may be generated as byproducts. If carbon monoxide and water generated as byproducts are supplied to fuel cell, the durability of the fuel cell installed in the electric vehicle may be reduced (e.g., due to catalyst poisoning, electrolyte degradation, or membrane fouling, etc.).

The first purification device 270 may include a methane generator for removing carbon monoxide contained in hydrogen gas, and/or a gas-liquid separator for removing moisture contained in hydrogen gas.

The methane generator converts carbon monoxide, which is generated as a byproduct when hydrogen is generated by the dehydrogenation reaction of a hydride and an acid aqueous solution inside the dehydrogenation reactor 220, into methane (e.g., via methanation reaction with hydrogen in the presence of a catalyst, etc.). In the methane generator, the gases of hydrogen and carbon monoxide discharged from the dehydrogenation reactor 220 pass through a catalyst, and the carbon monoxide is converted into methane. The catalyst of the methane generator may include at least one of nickel (Ni), ruthenium (Ru), cobalt (Co), rhodium (Rh), and iron (Fe) (e.g., selected based on reaction temperature, catalyst life, or tolerance to impurities, etc.). The catalyst is in a solid state, and may be in the form of, for example, granular, bead, microcapsule, or pellet (e.g., to increase surface area, enhance flow uniformity, or facilitate replacement, etc.).

The gas-liquid separator may separate excess moisture contained in hydrogen gas and discharge it to the outside (e.g., through a condensate drain, membrane separator, or knockout drum, etc.).

When recharging the hydride inside the dehydrogenation reactor 220, external air may be introduced into the dehydrogenation reactor 220 (e.g., during venting, maintenance, or material exchange, etc.). Alternatively, after a set amount of product is generated in the dehydrogenation reactor 220, impurity gas may be introduced into the dehydrogenation reactor 220 when re-reaction or partial restart occurs (e.g., due to incomplete sealing, ambient backflow, or purge valve failure, etc.).

In this way, when external air is introduced into the dehydrogenation reactor 220, overheating generated inside the dehydrogenation reactor 220 may create conditions that are prone to the generation of impurity gases such as carbon monoxide in addition to hydrogen gas, and the impurity gases introduced into the dehydrogenation reactor 220 may make it difficult to generate pure hydrogen gas (e.g., by interfering with catalytic efficiency, altering pH, or creating side reactions, etc.).

To prevent such problems, the hybrid hydrogen charging system according to an example may be equipped with a purging device 240 that discharges impurity gases inside the dehydrogenation reactor 220 to the outside (e.g., to maintain reaction purity, restore vacuum integrity, or prevent pressure spikes, etc.). The purging device 240 may discharge impurity gas inside the dehydrogenation reactor 220 to the outside through hydrogen gas above a set pressure (e.g., by opening the purging valve if internal pressure exceeds a threshold, etc.), or may discharge impurity gas inside the dehydrogenation reactor 220 to the outside through a vacuum pump 245 (e.g., by creating negative pressure during system shutdown, maintenance, or reactor replacement, etc.).

To this end, the purging device 240 may include a purging pipe 242 fluidly connecting the dehydrogenation reactor 220 of the solid-phase hydrogen supply system 200 to the outside, and a purging valve 244 provided in the purging pipe 242 downstream of the dehydrogenation reactor 220 (e.g., to control purge timing, regulate flow rate, or isolate the reactor during venting, etc.). If necessary, the vacuum pump 245 and a second purification device 247 provided in the purging pipe 242 downstream of the purging valve 244 to purify impurity gas discharged through the purging pipe 242 may be provided (e.g., to remove residual CO, water vapor, or particulate matter, etc.).

The inside of the dehydrogenation reactor 220 may be purged through negative pressure formed by the vacuum pump 245, and the impurity gas discharged from the dehydrogenation reactor 220 may be purified by the second purification device 247 and discharged to the outside (e.g., into a vent stack, filter housing, or safe exhaust path, etc.).

On the other hand, a booster pump 130 may be provided between the buffer tank 250 and the high-pressure hydrogen tank 110. The booster pump 130 may pump hydrogen gas stored in the buffer tank 250 and supply the hydrogen gas to the high-pressure hydrogen tank 110 (e.g., to increase throughput, support pressure equalization, or enhance compressor input flow, etc.). Accordingly, the hydrogen gas stored in the buffer tank 250 is supplied to the high-pressure hydrogen compressor 120 through the booster pump 130 (e.g., to maintain flow continuity, stabilize input pressure, or enhance compression efficiency, etc.) The high-pressure hydrogen compressor 120 compresses the hydrogen gas conveyed from a buffer tank 250 to a high pressure (e.g., suitable for 700 bar, 875 bar, or 1000 bar storage applications, etc.). The hydrogen gas compressed to a pressure higher than the reaction pressure in the dehydrogenation reactor 220 may be stored in the high-pressure hydrogen tank 110 (e.g., for subsequent dispensing, buffering for peak demand, or transfer to mobile storage, etc.).

The dispenser 30 for supplying hydrogen gas to the charging target 40 may be provided downstream of the high-pressure hydrogen tank 110 and downstream of the buffer tank 250 (e.g., to enable selectable delivery from either medium-pressure or high-pressure sources depending on the charging requirements, etc.). The dispenser 30 may selectively supply high-pressure hydrogen gas stored in the high-pressure hydrogen tank 110 and medium-pressure hydrogen gas stored in the buffer tank 250 to the charging target 40 (e.g., based on user selection, preset vehicle type, or target fill level, etc.).

The hybrid hydrogen charging system according to an example may include a controller 20 that controls each component of the hybrid hydrogen charging system based on driving information detected by a detector 10 (e.g., sensor outputs, pressure readings, or system feedback, etc.).

The controller 20 may be implemented with one or more processors that operate according to a predetermined program, and the memory of the controller 20 stores program instructions programmed to perform each step of the hybrid hydrogen charging method according to the present disclosure through one or more processors (e.g., microcontrollers, programmable logic controllers, or embedded systems, etc.).

The controller 20 may control the operation of the compressed hydrogen supply system 100 and the solid-phase hydrogen supply system 200 (e.g., start/stop sequencing, pressure regulation, or purge timing, etc.).

The detector 10 may include a flow sensor for detecting the amount of reactant inside the dehydrogenation reactor 220, a first pressure sensor for detecting the pressure inside the dehydrogenation reactor 220, a second pressure sensor for detecting the pressure inside the buffer tank 250, and a third pressure sensor for detecting the pressure inside the high-pressure hydrogen tank 110 (e.g., each implemented using MEMS sensors, piezoresistive sensors, or strain gauge transducers, etc.).

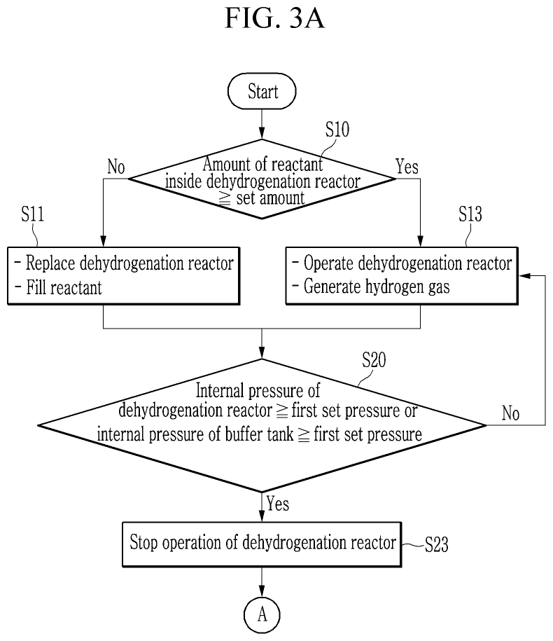

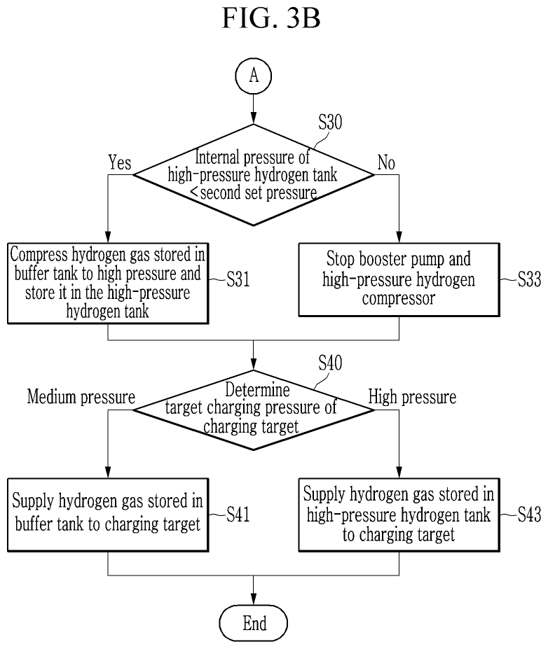

FIG. 3A and FIG. 3B show an example of a control method of a hybrid hydrogen charging system. The controller 20 determines whether the amount of reactant inside the dehydrogenation reactor 220 of the solid-phase hydrogen supply system is greater than or equal to a set amount through the detector 10 (S10) (e.g., based on a threshold corresponding to expected hydrogen yield or reaction duration, etc.).

If the amount of reactant inside the dehydrogenation reactor 220 is less than the set amount, the dehydrogenation reactor 220 is replaced, or the reactant is filled inside the dehydrogenation reactor 220 (S11) (e.g., using automated filling valves, replaceable cartridges, or manual refill ports, etc.).

If the amount of reactant inside the dehydrogenation reactor 220 is greater than or equal to the set amount, the controller 20 operates the dehydrogenation reactor 220 to generate hydrogen gas, and the generated hydrogen gas is stored in the buffer tank 250 (S13) (e.g., for temporary storage, flow regulation, or preparation for compression to high-pressure storage, etc.).

The controller 20 determines whether the internal pressure of the dehydrogenation reactor 220 is greater than or equal to the first set pressure (e.g., 350 to 700 bar), or whether the internal pressure of the buffer tank 250 is equal to or greater than the first set pressure (S20) (e.g., to decide whether to continue or suspend hydrogen generation or initiate compression to high-pressure storage, etc.).

If the internal pressure of the dehydrogenation reactor 220or the buffer tank 250 is less than the first set pressure, the controller 20 continues to operate the dehydrogenation reactor 220 to generate hydrogen gas (S11) (e.g., to maintain sufficient supply for immediate dispensing or subsequent compression, etc.).

If the internal pressure of the dehydrogenation reactor 220or the buffer tank 250 is higher than the first set pressure, the controller 20 stops operating the dehydrogenation reactor 220 (S23) (e.g., to prevent over pressurization, ensure system safety, or optimize thermal load, etc.).

That is, the controller 20 may determine whether the dehydrogenation reactor 220 is operating based on the internal pressure of the dehydrogenation reactor 220 or the buffer tank 250 (e.g., via comparison with a pressure threshold or time-weighted average, etc.).

The controller 20 determines whether the internal pressure of the high-pressure hydrogen tank 110 is less than the second set pressure (e.g., 700 to 1,000 bar, depending on the specifications of the dispensing system, vehicle class, or storage protocol, etc.) (S30).

If the internal pressure of the high-pressure hydrogen tank 110 is less than the second set pressure, the controller 20 operates the booster pump and the high-pressure hydrogen compressor 120 to compress the hydrogen gas stored in the buffer tank 250 to high pressure and store the hydrogen gas in the high-pressure hydrogen tank 110 (S31) (e.g., to replenish storage, support high-pressure vehicle charging, or maintain readiness for peak demand, etc.). In this case, until the internal pressure of the high-pressure hydrogen tank 110 reaches the second set pressure, the controller 20 operates the booster pump and the high-pressure hydrogen compressor 120 to compress the hydrogen gas stored in the buffer tank 250 and store the hydrogen gas in the high-pressure hydrogen tank 110 (e.g., using staged control or pressure feedback loops, etc.).

If the internal pressure of the high-pressure hydrogen tank 110 is higher than or equal to the second set pressure, the controller 20 stops operating the booster pump and the high-pressure hydrogen compressor 120 (S33) (e.g., to conserve energy, avoid overcharging, or trigger idle state, etc.).

That is, the controller 20 may determine whether to operate the booster pump and the high-pressure hydrogen compressor 120 based on the internal pressure of the high-pressure hydrogen tank 110 (e.g., to maintain optimal storage levels, prevent over-pressurization, or synchronize with vehicle fueling demand, etc.).

The controller 20 may supply hydrogen gas stored in the high-pressure hydrogen tank 110 to the charging target 40 based on the target charging pressure of the charging target 40, or supply hydrogen gas stored in the buffer tank 250 to the charging target 40 (e.g., depending on whether the target requires high-pressure fueling for long-range vehicles or medium-pressure fueling for lighter-duty applications, etc.). The target charging pressure of the charging target 40 may be determined through user input (S40) (e.g., via touchscreen interface, vehicle-docking signal, or preset configuration, etc.).

For example, if the target charging pressure of the charging target 40 is in a medium-pressure range (e.g., 350 to 700 bar), the controller 20 supplies hydrogen gas stored in the buffer tank 250 to the charging target 40 through the dispenser 30 (e.g., suitable for fleet vehicles, hydrogen-powered drones, or backup power systems, etc.). And if the target charging pressure of the charging target 40 is in the high-pressure range (e.g., 700 to 1,000 bar), the controller 20 supplies hydrogen gas stored in the high-pressure hydrogen tank 110 to the charging target 40 through the dispenser 30 (e.g., for fueling passenger FCEVs, commercial trucks, or high-capacity hydrogen transport modules, etc.).

In other words, the controller 20 determines the target charging pressure of the charging target 40 (S40), and if the target charging pressure of the charging target 40 is in the medium-pressure range, the controller 20 supplies hydrogen gas stored in the buffer tank 250 to the charging target 40 through the dispenser 30 (S41) (e.g., for applications such as industrial forklifts, light-duty vehicles, or portable hydrogen devices, etc.). Further, if the target charging pressure of the charging target 40 is in the high-pressure range, the controller 20 supplies hydrogen gas stored in the high-pressure hydrogen tank 110 to the charging target 40 through the dispenser 30 (S43) (e.g., to ensure appropriate fueling rate, meet vehicle pressure specs, or optimize refueling efficiency, etc.).

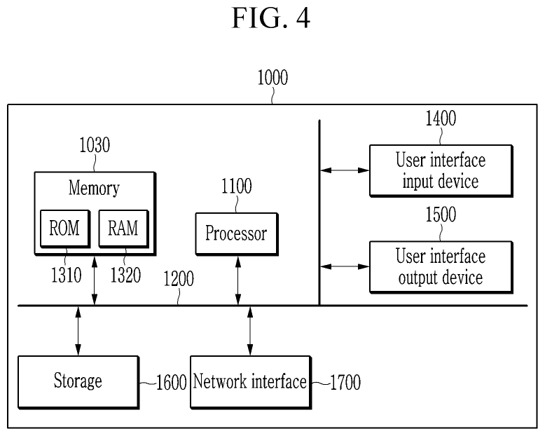

FIG. 4 shows an example computing system (e.g., a computing device of a hybrid hydrogen charging system, a vehicle, or any other apparatus)

One or more controllers, processors, etc. described herein, such as one or more components of a hybrid hydrogen charging system, one or more components of a vehicle, and any other components and devices disclosed herein, may be implemented by or in the computing system as shown in FIG. 4.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

A hybrid hydrogen charging system according to an example includes a solid-phase hydrogen supply system that generates hydrogen gas at a medium-pressure range by a chemical reaction of chemical hydride, a compressed hydrogen supply system that selectively pressurizes hydrogen gas generated by the solid-phase hydrogen supply system to a predetermined high-pressure range, and a dispenser selectively supplying hydrogen gas of the solid-phase hydrogen supply system and the compressed hydrogen supply system to a charging target.

In some examples, the compressed hydrogen supply system may include a high-pressure hydrogen compressor pressurizing hydrogen gas generated in the solid-phase hydrogen supply system, and a high-pressure hydrogen tank storing hydrogen gas pressurized by the high-pressure hydrogen compressor.

In some examples, the solid-phase hydrogen supply system may include an acid aqueous solution tank storing acid aqueous solution, at least one dehydrogenation reactor storing the chemical hydride and selectively supplying the acid aqueous solution stored in the acid aqueous solution tank to generate hydrogen gas, and a thermal control device controlling the temperature of the dehydrogenation reactor.

In some examples, the solid-phase hydrogen supply system may further include a purging device discharging impurity gas inside the dehydrogenation reactor.

In some examples, the purging device may include a purging pipe fluidly connecting the dehydrogenation reactor to the outside, and a purging valve provided in the purging pipe downstream of the dehydrogenation reactor.

In some examples, the purging device may further include a vacuum pump provided in the purging pipe downstream of the purging valve.

In some examples, a buffer tank temporarily storing hydrogen gas generated in the dehydrogenation reactor may be further included.

In some examples, the compressed hydrogen supply system may further include a booster pump provided between the buffer tank and the high-pressure hydrogen tank.

In some examples, the solid-phase hydrogen supply system may further include a back-pressure regulator provided upstream of the buffer tank, and a first purification device provided upstream of the back-pressure regulator.

A hybrid hydrogen charging method including a compressed hydrogen supply system and a solid-phase hydrogen supply system includes determining whether the dehydrogenation reactor is operating based on the internal pressure of a dehydrogenation reactor or a buffer tank of the solid-phase hydrogen supply system, determining whether a booster pump and a high-pressure hydrogen compressor of the compressed hydrogen supply system are operating based on the internal pressure of a high-pressure hydrogen tank of the compressed hydrogen supply system, and supplying hydrogen gas stored in the high-pressure hydrogen tank of the compressed hydrogen supply system to the charging target based on the target charging pressure of the charging target, or supplying hydrogen gas stored in the buffer tank of the solid-phase hydrogen supply system to the charging target.

In some examples, the determining of whether the dehydrogenation reactor is operating may include determining whether the internal pressure of the dehydrogenation reactor or the buffer tank is greater than or equal to a first set pressure.

In some examples, if the internal pressure of the dehydrogenation reactor or the buffer tank is less than the first set pressure, the dehydrogenation reactor may be operated to generate hydrogen gas.

In some examples, if the internal pressure of the dehydrogenation reactor or the buffer tank is greater than or equal to the first set pressure, operation of the dehydrogenation reactor may be stopped.

In some examples, the determining of whether the booster pump and the high-pressure hydrogen compressor of the compressed hydrogen supply system are operating may include determining whether the internal pressure of the high-pressure hydrogen tank of the compressed hydrogen supply system is less than a second set pressure.

In some examples, if the internal pressure of the high-pressure hydrogen tank is less than the second set pressure, the booster pump and the high-pressure hydrogen compressor of the compressed hydrogen supply system may be operated to compress hydrogen gas stored in the buffer tank and store the hydrogen gas in the high-pressure hydrogen tank.

In some examples, if the internal pressure of the high-pressure hydrogen tank is greater than or equal to the second set pressure, operation of the booster pump and the high-pressure hydrogen compressor may be stopped.

According to examples, by first generating hydrogen gas in a medium-pressure range using chemical hydride with a relatively light weight, and secondarily compressing the hydrogen gas to a high-pressure range through a compressor, it is possible to reduce the transportation cost required to supply the hydrogen gas to a hydrogen charging station, and reduce carbon emissions.

According to an example of the hybrid hydrogen charging system and method, instead of supplying a hydrogen tank filled with hydrogen to an existing hydrogen charging station by a trailer, etc., a chemical hydride with a relatively light weight is used to first generate hydrogen gas in a medium-pressure range, and then the hydrogen gas is secondarily compressed to a high-pressure range by a compressor, thereby reducing the transportation cost required to supply the hydrogen gas to a hydrogen charging station and reducing carbon emissions.

In addition, it is possible to reduce the space required to park trailers equipped with hydrogen tanks at existing hydrogen charging stations and the space required to store hydrogen tanks.

While this disclosure has been described in connection with what is presently considered to be practical examples, it is to be understood that the disclosure is not limited to the disclosed examples, but on the contrary, is intended to cover various modifications and equivalent arrangements included within the spirit and scope of the appended claims.

What is claimed is:

1. An apparatus comprising:
a solid-phase hydrogen supply system configured to generate, based on a chemical reaction of a chemical hydride, hydrogen gas in a first pressure range;
a compression system configured to selectively change a pressure of the hydrogen gas generated by the solid-phase hydrogen supply system to a second pressure range that extends beyond the first pressure range; and
a dispenser configured to provide hydrogen gas to a charging target from at least one of the solid-phase hydrogen supply system or the compression system.

2. The apparatus of claim 1, wherein
the compression system comprises:
a hydrogen compressor configured to pressurize the hydrogen gas generated by the solid-phase hydrogen supply system; and
a hydrogen tank configured to store the hydrogen gas pressurized by the hydrogen compressor.

3. The apparatus of claim 2, wherein
the solid-phase hydrogen supply system comprises:
an acid aqueous solution tank configured to store acid aqueous solution;
at least one dehydrogenation reactor configured to store the chemical hydride and selectively provide the acid aqueous solution stored in the acid aqueous solution tank to generate hydrogen gas; and
a cooler configured to control a temperature of the at least one dehydrogenation reactor.

4. The apparatus of claim 3, wherein
the solid-phase hydrogen supply system further comprises:
a purging assembly configured to discharge impurity gas from the dehydrogenation reactor.

5. The apparatus of claim 4, wherein
the purging assembly comprises:
a purging pipe configured to fluidly connect the dehydrogenation reactor to a discharge outlet located outside the solid-phase hydrogen supply system; and
a purging valve provided in the purging pipe, downstream of the dehydrogenation reactor.

6. The apparatus of claim 5, wherein
the purging assembly further comprises:
a vacuum pump provided in the purging pipe, downstream of the purging valve.

7. The apparatus of claim 3, further comprising:
a buffer tank configured to temporarily store hydrogen gas generated from the at least one dehydrogenation reactor of the solid-phase hydrogen supply system.

8. The apparatus of claim 7, wherein
the compression system further comprises:
a booster pump provided between the buffer tank and the hydrogen tank of the compression system.

9. The apparatus of claim 7, wherein
the solid-phase hydrogen supply system comprises
a back-pressure regulator provided upstream of the buffer tank; and
a gas purifier provided upstream of the back-pressure regulator.

10. A method performed by an apparatus comprising a compression system and a solid-phase hydrogen supply system, the method comprising:
determining, based on an internal pressure of a dehydrogenation reactor of the solid-phase hydrogen supply system or an internal pressure of a buffer tank of the solid-phase hydrogen supply system, whether the dehydrogenation reactor is performing a dehydrogenation reaction to generate hydrogen gas;
determining, based on an internal pressure of a hydrogen tank of the compression system, whether a booster pump of the compression system and a hydrogen compressor of the compression system are compressing hydrogen gas from the buffer tank into the hydrogen tank; and
supplying, based on a required charging pressure associated with a charging target, hydrogen gas to the charging target by:
supplying hydrogen gas stored in the hydrogen tank of the compression system to the charging target, or
supplying hydrogen gas stored in the buffer tank of the solid-phase hydrogen supply system to the charging target.

11. The method of claim 10, wherein
the determining of whether the dehydrogenation reactor is performing the dehydrogenation reaction to generate hydrogen gas comprises:
determining whether the internal pressure of the dehydrogenation reactor or the internal pressure of the buffer tank is greater than or equal to a first set pressure.

12. The method of claim 11, further comprising:
based on the internal pressure of the dehydrogenation reactor or the internal pressure of the buffer tank being less than the first set pressure, controlling the dehydrogenation reactor to perform the dehydrogenation reaction to generate hydrogen gas.

13. The method of claim 12, further comprising:
based on the internal pressure of the dehydrogenation reactor or the internal pressure of the buffer tank being greater than or equal to the first set pressure, stopping the performance of the dehydrogenation reaction by the dehydrogenation reactor.

14. The method of claim 10, wherein the determining of whether the booster pump and the hydrogen compressor are compressing hydrogen gas from the buffer tank into the hydrogen tank comprises:
determining whether the internal pressure of the hydrogen tank is less than a second set pressure.

15. The method of claim 14, further comprising:
based on the internal pressure of the hydrogen tank being less than the second set pressure, operating the booster pump and the hydrogen compressor to compress hydrogen gas stored in the buffer tank and store the compressed hydrogen gas in the hydrogen tank.

16. The method of claim 15, further comprising:
based on the internal pressure of the hydrogen tank being greater than or equal to the second set pressure, stopping operations of the booster pump and the hydrogen compressor.

17. An apparatus comprising:
a solid-phase hydrogen generation system configured to produce hydrogen gas via a reaction between a solid-phase hydrogen storage material and a reactive liquid;
a storage vessel configured to receive and store the hydrogen gas generated by the solid-phase hydrogen generation system;
a compressor configured to increase a pressure of the hydrogen gas from the storage vessel;
a tank configured to store the hydrogen gas compressed by the compressor; and
a dispenser configured to supply hydrogen gas to a hydrogen-receiving device from at least one of the storage vessel or the tank.

18. The apparatus of claim 17, wherein the solid-phase hydrogen generation system comprises:
an acid aqueous solution tank configured to store an acid aqueous solution; and
a dehydrogenation reactor configured to receive a chemical hydride and mix the acid aqueous solution with the chemical hydride to produce hydrogen gas.

19. The apparatus of claim 17, further comprising a cooler configured to control a temperature of a dehydrogenation reactor of the solid-phase hydrogen generation system, wherein the cooler comprises a chiller and a cooling pump.

20. The apparatus of claim 17, wherein the dispenser is configured to:
based on a charging pressure of the hydrogen-receiving device being within a first pressure range, supply hydrogen gas from the storage vessel, and
based on the charging pressure being within a second pressure range, supply hydrogen gas from the tank.
